(19) United States
(12) Patent Application Publication
(10) Pub. No.: US 2005/0119024 A1
(43) Pub. Date: Jun. 2, 2005

(54) Wireless terminals

(76) Inventor: Kevin Robert Boyle, Horsham (GB)

Correspondence Address: PHILIPS INTELLECTUAL PROPERTY & STANDARDS, P.O. BOX 3001, BRIARCLIFF MANOR, NY, 10510, US

(21) Appl. No.: 10/507,993

(22) PCT Filed: Feb. 12, 2003
(86) PCT No.: PCT/IB03/00550

(30) Foreign Application Priority Data
Mar. 21, 2002 (GB) 0206670.2

(51) Int. Cl. H04M 1/00

(52) U.S. Cl. 455/550.1; 455/90.3

(57) ABSTRACT

A wireless terminal comprises a radio frequency stage (20) coupled to a signal propagator (22). The signal propagator comprises a folded dipole formed by an aperture (40), for example a T-shaped aperture, in at least the ground plane of a printed circuit board (PCB). The width (c) of the aperture is small relative to the area of the ground plane and is substantially smaller than its length (a). A feed (42) couples an output of the radio frequency stage (20) to the aperture (40).

### TECHNICAL FIELD

The present invention relates to improvements in or relating to wireless terminals and has particular, but not exclusive, application to mobile phone handsets operating in accordance with single or dual standards, such as GSM and DCS.

### BACKGROUND ART

Wireless terminals, such as mobile phone handsets, typically incorporate either an external antenna, such as a normal mode helix or meander line antenna, or an internal antenna, such as a Planar Inverted-F Antenna (PIFA) or similar.

Such antennas are small (relative to a wavelength) and therefore, owing to the fundamental limits of small antennas, narrowband. However, cellular radio communication systems typically have a fractional bandwidth of 10% or more. To achieve such a bandwidth from a PIFA for example requires a considerable volume, there being a direct relationship between the bandwidth of a patch antenna and its volume, but such a volume is not readily available with the current trends towards small handsets. Hence, because of the limits referred to above, it is not feasible to achieve efficient wideband radiation from small antennas in present-day wireless terminals.

A further problem with known antenna arrangements for wireless terminals is that they are generally unbalanced, and therefore couple strongly to the terminal case. As a result a significant amount of radiation emanates from the terminal itself rather than the antenna. A wireless terminal in which an antenna feed is directly coupled to the terminal case or ground conductor, thereby taking advantage of this situation, is disclosed in our co-pending International Patent Application WO02/13306 (Applicant's reference PHGB010056). The coupling may be by way of a parallel plate capacitor formed by a surface of the case and a plate mounted spaced from the surface. The terminal case acts as an efficient, wideband radiator, eliminating the need for a separate antenna. In a variant a quarter wavelength slot is provided in the case to increase the resistance of the case as seen by the RF stage, thereby increasing the radiating bandwidth of the terminal.

Although the provision of the quarter wavelength slot does enhance the performance of the wireless terminal a disadvantage is that it is difficult to achieve the length at GSM frequencies of 880 MHz to 960 MHz because of the desire to compromise between mounting relatively large components, such as display panels, on a PCB (printed circuit board) and reducing the overall size of the wireless terminal.

In an alternative approach to feeding the PCB, it is divided into two and feed it as a dipole. This has been found to work well at GSM frequencies but has the disadvantage that circuit connections can only be made across the gap by way of high impedance connections.

### DISCLOSURE OF INVENTION

An object of the present invention is to facilitate the feed of signals to a PCB functioning as an antenna whilst achieving a desired bandwidth.

According to one aspect of the present invention there is provided a wireless terminal comprising a radio frequency stage having an output and signal propagation means coupled to the output, the signal propagation means comprising a folded dipole formed by an aperture in at least the ground plane of a printed circuit board, the aperture being small relative to the area of the ground plane, and feed means for coupling the output to the aperture.

According to a second aspect of the present invention there is provided an integrated RF module comprising a radio frequency stage having an output and signal propagation means coupled to the output, the signal propagation means comprising a folded dipole formed by an aperture in at least the ground plane of a printed circuit board, the aperture being small relative to the area of the ground plane, and feed means for coupling the output to the aperture.

The aperture may comprise a rectilinear portion communicating at its inner end with a transversely extending portion. As an example the aperture is T-shaped.

### BRIEF DESCRIPTION OF DRAWINGS

The present invention will now be described, by way of example, with reference to the accompanying drawings, wherein:

FIG. 1 is a block schematic diagram of a transceiver coupled to a folded dipole printed circuit board (PCB) antenna,

FIG. 2 is a sketch of a folded dipole PCB antenna,

FIG. 3 is a diagram showing the radiating and balanced modes of the folded dipole PCB antenna,

FIG. 4 is a Smith chart of a minimal aperture folded PCB antenna (MAFPA) showing the measured impedances over the range of GSM and DCS frequencies,

FIG. 5 is a Smith chart of the MAFPA with independent matching over the range of GSM frequencies,

FIG. 6 is a graph of measured return loss S₁₁ in dB against frequency in GHz for the MAFPA shown in FIG. 2 over the range of GSM frequencies,

FIG. 7 is a Smith chart of the MAFPA with independent matching over the range of DCS frequencies,

FIG. 8 is a graph of measured return loss S₁₁ in dB against frequency in GHz for the MAFPA shown in FIG. 2 over the range of DCS frequencies,

FIG. 9 is a schematic circuit diagram of a GSM and DCS diplexer,

FIG. 10 is a Smith diagram of the performance of the MAFPA when coupled to the diplexer shown in FIG. 9 and operated at the GSM and DCS ranges of frequencies,

FIG. 11 is a graph of measured return loss S₁₁ in dB against frequency in GHz for the MAFPA when coupled to the diplexer shown in FIG. 9 and operated at the GSM and DCS ranges of frequencies, and

FIGS. 12 to 15 are sketches of a portion of a PCB showing different aperture shapes.

In the drawings the same reference numerals have been used to indicate corresponding features.

### MODES FOR CARRYING OUT THE INVENTION

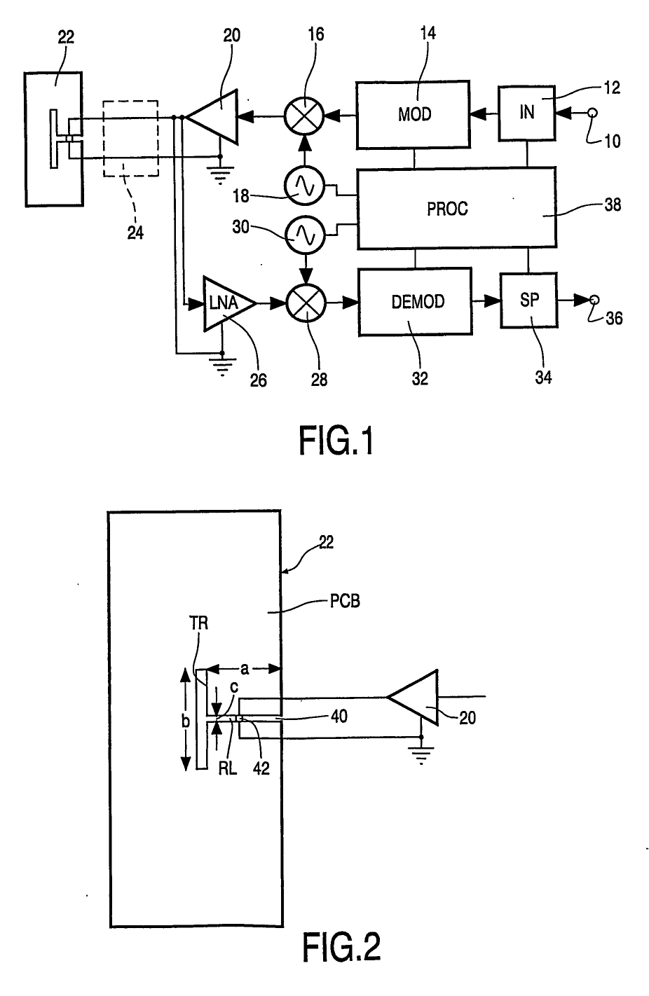

Referring to FIG. 1, the transceiver comprises a transmitter section including a signal input terminal 10 coupled to an input signal processing stage (IN) 12. The stage 12 is coupled to a modulator (MOD) 14 which provides a modulated signal to a frequency up-converter comprising a multiplier 16 to which a signal generator 18, such as a frequency synthesiser, is also connected. The frequency up-converted signal is coupled to a signal propagator 22 by way of a power amplifier 20 and, optionally, a diplexer 24.

A receiver section of the transceiver comprises a low noise amplifier 26 coupled to the signal propagator 22, optionally, by way of the diplexer 24. An output of the low noise amplifier 26 is coupled to a frequency down-converter comprising a multiplier 28 and a signal generator 30, such as a frequency synthesiser. The frequency down-converted signal is demodulated in a demodulator (DEMOD) 32 and its output is applied to a signal processing stage (SP) 34 which provides an output signal on a terminal 36. The operation of the transceiver is controlled by a processor (PROC) 38.

Irrespective of how the transceiver and the diplexer are implemented the signal propagator 22 comprises a minimal aperture folded PCB antenna (MAFPA) which is shown more clearly in FIG. 2. The MAFPA 22 comprises a printed circuit board PCB of a size which is typical of that used in currently produced mobile phones, say 40 mm×100 mm×1 mm. In the illustrated example a T-shaped aperture 40 is made in the PCB by either removing the material of the PCB or by etching away the metallisation. In the illustrated example the aperture 40 as viewed comprises a horizontal, rectilinear portion RL having a length (dimension “a”) of 20 mm and a vertical, transversely extending portion TR having a length (dimension “b”) of 22 mm. Both portions are 2 mm wide (dimension “c”). A feed 42 is located along one limb of the aperture 40, the actual connections being made in the normal manner in the folded section of the PCB.

The size of the aperture 40 is small enough that this could be done on a module that is installed on another PCB having a sympathetic aperture. Thus the antenna aperture 40 and the feed 42 could be part of an integrated RF module.

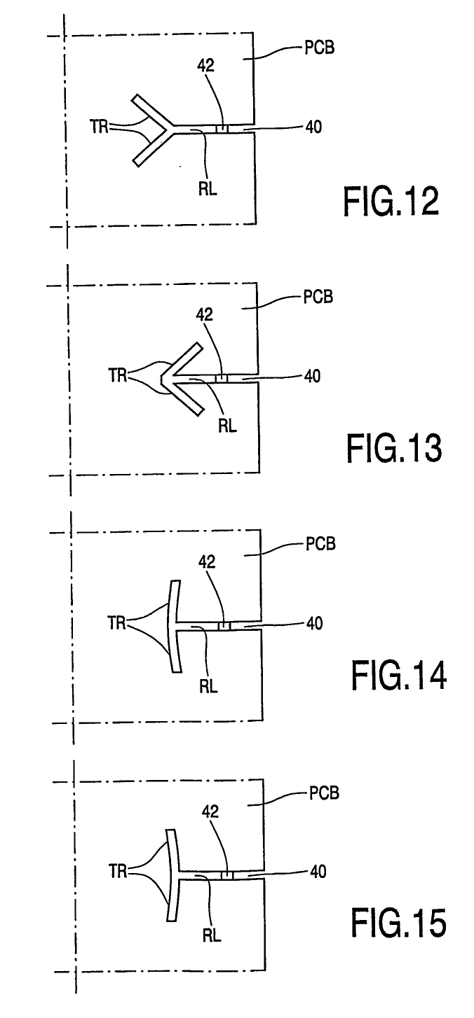

The aperture 42 could be of any suitable shape besides that shown in FIG. 2 subject to the resulting PCB constituting a MAFPA. Examples of other suitable shapes are shown in FIGS. 12 to 15. In FIG. 12 the aperture 40 is of a Y-shape with the transversely extending portion TR being generally V-shaped and diverging away from the inner end of the rectilinear portion RL. The aperture in FIG. 13 is of an arrow head shape with the transversely extending portion TR being generally V-shaped and diverging from the inner end of the rectilinear portion RL in a direction towards the edge of the PCB. In FIGS. 14 and 15 the transversely extending portions TR are curvilinear with the opposite directions of curvature. The size of the feed aperture is minimised by having a high radiating mode transformation ratio and a short transmission line in the balanced mode. Circuitry is used subsequently to match the MAFPA 22 back to a desired impedance, such as 50 ohms.

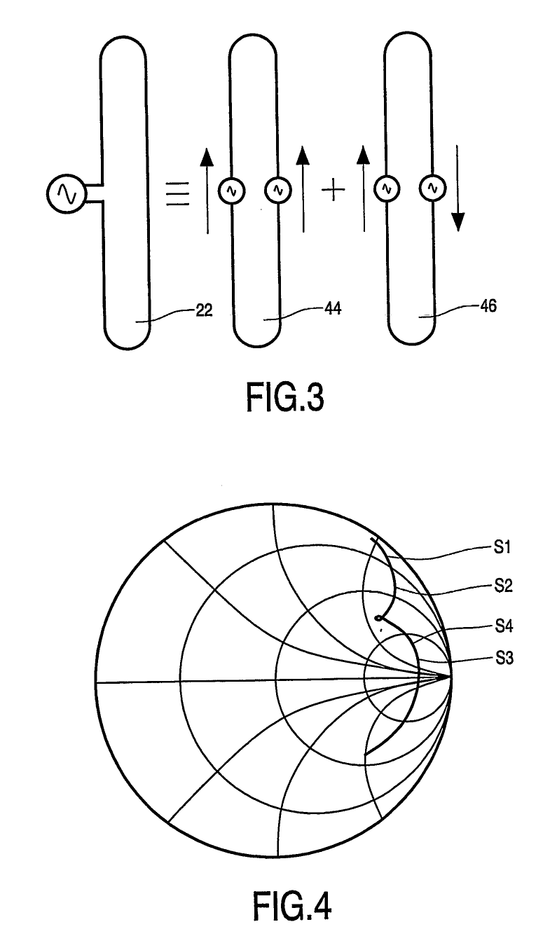

FIG. 3 illustrates these two modes. The MAFPA 22 is shown to be equivalent to the sum of a folded loop 44 having a high radiating mode transformation ratio and a folded loop 46 functioning as a short transmission line in the balanced mode. The arrows indicate the direction of current flow.

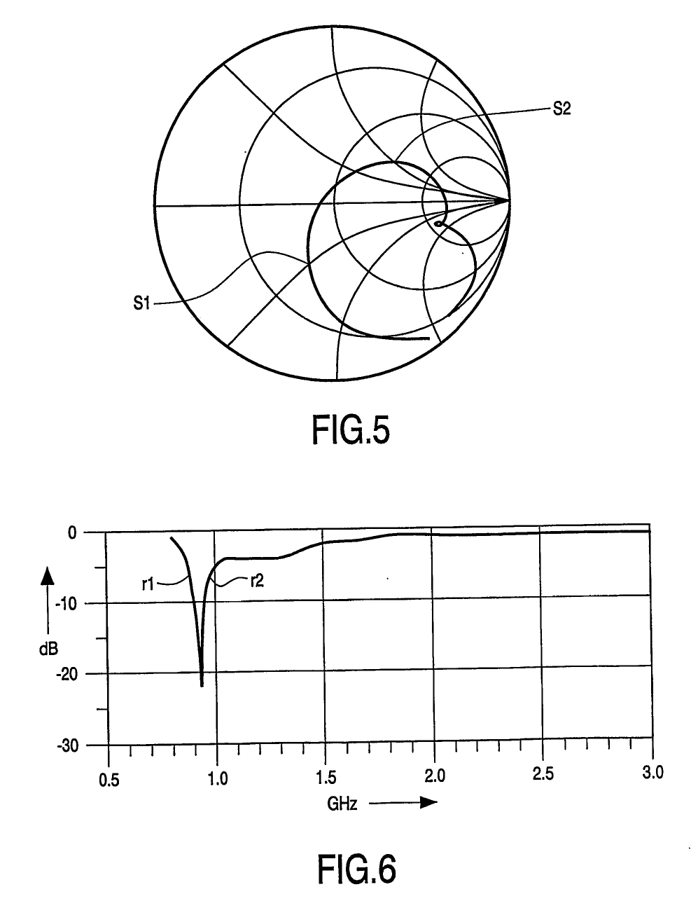

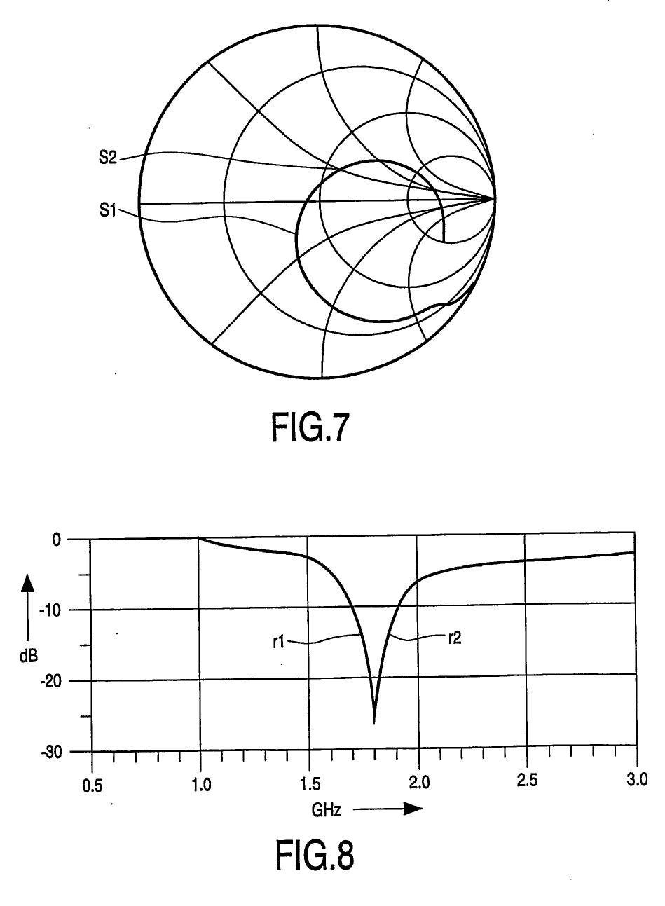

FIG. 4 is a Smith chart showing S₁₁ of the MAFPA configuration shown in FIG. 2 when used in the GSM band of 880 to 960 MHz and the DCS band of 1.880 to 1.710 GHz. The points referenced are as follows: s1=880 MHz, s2=960 MHz, s3=1.880 GHz and s4=1.710 GHz. It can be deduced from the Smith chart that the MAFPA has a high impedance due to the radiating mode impedance transformation and is inductive due to the reactance of the balanced mode. Both these effects result from the small aperture. However the impedance is still such that it can be matched over a bandwidth that is wide enough for operation over these two cellular frequency bands. This illustrated more clearly in FIGS. 5 to 8. FIGS. 5 and 6 relate to the GSM frequency band and FIGS. 7 and 8 relate to the DCS frequency band.

In FIG. 5 the points s1 and s2 relate to 880 and 960 MHz, respectively, and in FIG. 6 the return losses at 880 (r1) and 960 (r2) MHz are −6.633 and −7.362, respectively. These return losses of better than −6 dB at the edges of the GSM band are achieved by using a shunt capacitor of 0.5 pF connected across the feed followed by a series capacitor of 0.9 pF.

In FIG. 7 the points s1 and s2 relate to 1.710 and 1.875 GHz, respectively, and in FIG. 8 the return losses at 1.710 (r1) and 1.880 (r2) GHz are −12.836 and −12.803, respectively. These return losses of better than −12 dB at the edges of the DCS band are achieved by using a shunt inductor of 17 nH connected-across the feed followed by a series capacitor of 0.7 pF.

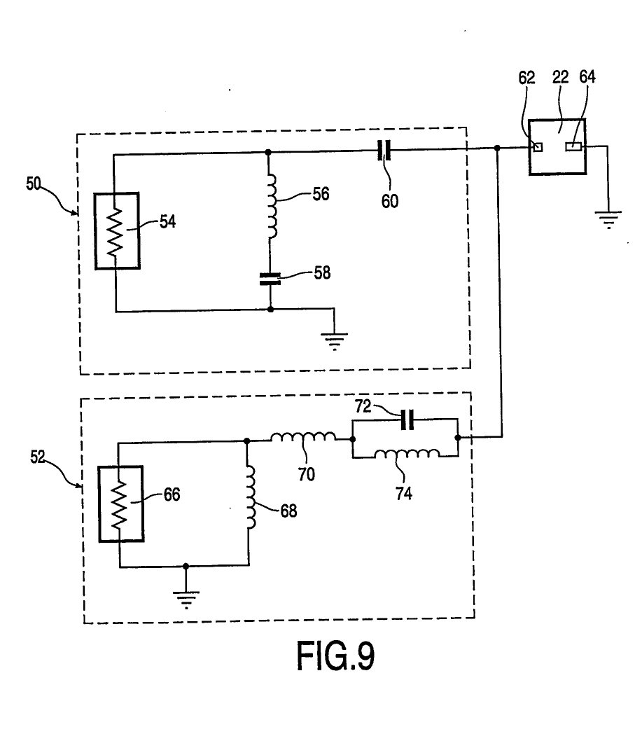

In practice dual band matching may be possible. Alternatively the matching can be integrated into a diplexer as shown for example in FIG. 9. The components for matching the antenna 22 to 50 ohm impedance at GSM frequencies are shown in the broken line box 50 and for matching the antenna 22 to 50 ohms at DCS frequencies are shown in the broken line box 52. Referring to the box 50, a 50 ohm resistance 54 is shunted by a series combination of a 5.0 nH inductance 56 and 1.5723 pF capacitance 58 which has a low impedance at DCS frequencies. One side of the parallel combination is connected to ground whilst the other side is connected by a 2.0 pF series capacitor 60 to one side of the antenna feed, the other side being connected to ground.

The box 52 comprises a parallel combination of a 50 ohm resistor 66 and a 3.5 nH inductance 68, one side of which combination is connected to ground and the other side of which is coupled to one end of a 5.0 nH series inductance 70. The other side of the inductance 70 is coupled by way of a parallel combination of a 3.325 pF capacitor 72 and a 9.0 nH inductance 74 to the one side 62 of the antenna feed. The parallel combination of the capacitor 72 and the inductance 74 offers a high impedance to GSM signals.

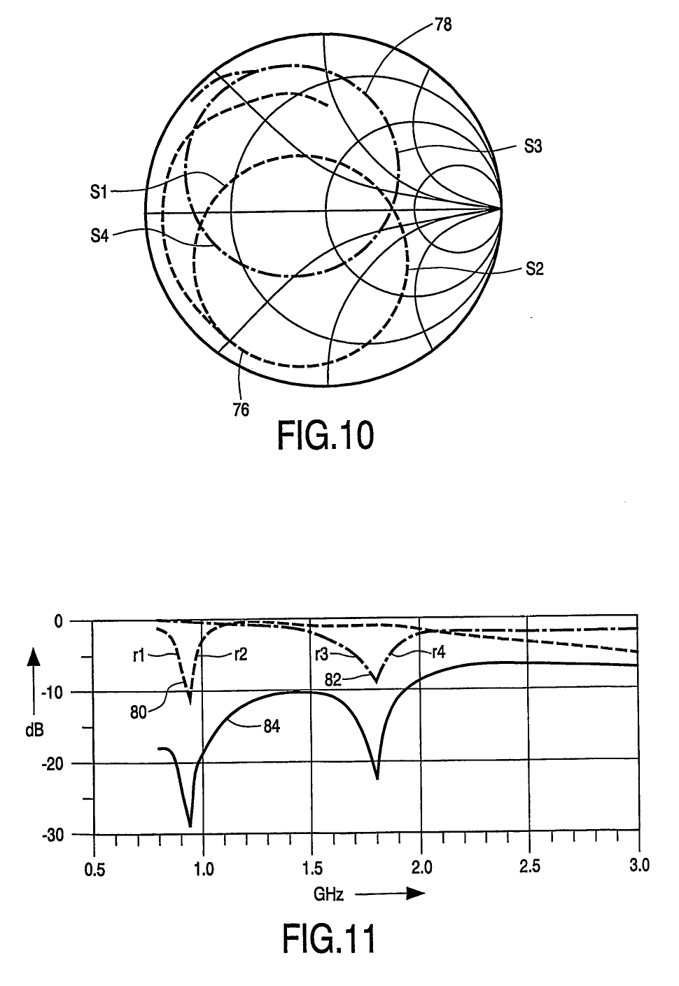

FIG. 10 is a Smith chart showing the response of the diplexer circuit in both the GSM and DCS frequency bands. The broken line curve 76 refers to GSM and the points s1 and s2 refer to 880 and 960 MHz, respectively. The chain-dot line 78 refers to DCS and the points s3 and s4 refer to 1.710 and 1.880 GHz, respectively. It can be seen that a band edge S₁₁ of approximately −5 dB is achieved.

In FIG. 11 the broken line curve 80 relates to the measured return loss S₁₁ at GSM frequencies and the points r1 and r2 indicate the return losses of −5.381 and −4.716 at the frequencies 880 and 960 MHz, respectively. The chain-dot curve 82 relates to the measured return loss S₁₁ at DCS frequencies and the points r3 and r4 indicate the return losses of −5.922 and −4.894 at the frequencies 1.710 and 1.880 GHz, respectively. For the sake of completeness the curve 84 illustrates the quality of isolation of the diplexer shown in FIG. 9.

An alternative method of providing dual band performance is to provide two feeds. In this way, with suitable filtering, in the GSM band the PCB could be used as a folded dipole while in the DCS mode, the PCB could be used as a directly fed notch. Additional frequency bands could also be added based on the combination of the principles outlined above.

Although the present invention has been described with reference to a dual band arrangement, the present invention can be applied to any field where radiation is required from a device with a wavelength scale PCB.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of wireless terminals having a folded dipole antenna and component parts therefor and which may be used instead of or in addition to features already described herein.

1. A wireless terminal comprising a radio frequency stage having an output and signal propagation means coupled to the output, the signal propagation means comprising a folded dipole formed by an aperture in at least the ground plane of a printed circuit board, the aperture being small relative to the area of the ground plane, and feed means for coupling the output to the aperture.

2. A terminal as claimed in claim 1, characterised in that the aperture comprises a rectilinear portion extending from an edge of the printed circuit board and a transversely extending portion communicating with an inner end of the rectilinear portion.

3. A terminal as claimed in claim 1, characterised in that the width of the aperture is smaller than the length of the rectilinear portion.

4. A terminal as claimed in claim 1, characterised in that the aperture is of T-shape.

5. A terminal as claimed in any one of claims 1 to 4, characterised in that the output is coupled to the signal propagation means by matching components.

6. A terminal as claimed in any one of claims 1 to 4, characterised by a diplexer coupling the output to the signal propagation means, the diplexer being adapted to supply signals in at least two signal bands to the signal propagation means.

7. An integrated RF module comprising a radio frequency stage having an output and signal propagation means coupled to the output, the signal propagation means comprising a folded dipole formed by an aperture in at least the ground plane of a printed circuit board, the aperture being small relative to the area of the ground plane, and feed means for coupling the output to the aperture.

8. A module as claimed in claim 7, characterised in that the aperture comprises a rectilinear portion extending from an edge of the printed circuit board and a transversely extending portion communicating with an inner end of the rectilinear portion.

9. A module as claimed in claim 8, characterised in that in that the width of the aperture is smaller than the length of the rectilinear portion.

10. A module as claimed in claim 7, characterised in that the aperture is of T-shape.

11. A module as claimed in any one of claims 7 to 10, characterised in that the output is coupled to the signal propagation means by matching components.

12. A module as claimed in any one of claims 7 to 10, characterised by a diplexer coupling the output to the signal propagation means, the diplexer being adapted to supply signals in at least two signal bands to the signal propagation means.
